(19) United States
(12) Patent Application Publication
(10) Pub. No.: US 2025/0266734 A1
(43) Pub. Date: Aug. 21, 2025

(54) STOCK SERVOMOTOR STRUCTURE OF INJECTION MOLDING MACHINE

(71) Applicant: Po-Fong LIN, Taipei City (TW)

(72) Inventor: Po-Fong LIN, Taipei City (TW)

(21) Appl. No.: 18/444,715

(22) Filed: Feb. 18, 2024

(51) Int. Cl. H02K 5/15; B29C 45/17

(52) U.S. Cl. CPC H02K 5/15; B29C 45/17; B29C 2045/1794

(57) ABSTRACT

A stock servomotor structure of an injection molding machine, comprising: a shell, a rotor shaft, a front cover and a rear cover, wherein the shell has an accommodating space inside, a convex ring part is configured on one side of the rotor shaft and an opening is configured on one side end, the front cover has a single row tapered roller bearing and a spherical roller thrust bearing, the front cover has a through hole on two sides, the rear cover has a rolling bearing. The stock servomotor is configured with the single row tapered roller bearing, the spherical roller thrust bearing and the rolling bearing to clamp the rotor shaft and bear the axial force loading generated by the injection molding machine and the stock servomotor is configured to directly drive the threaded rod of the injection molding machine to rotate.

### BACKGROUND OF THE INVENTION

The present invention relates to a stock servomotor structure, and more particularly to a structure capable of bearing the axial force loading generated during the manufacturing process of an injection molding machine to inject molding product, thereby improving the running to be smooth and reducing the wastage of the machine components and saving energy.

### DESCRIPTION OF THE RELATED ART

Accordingly, a conventional servomotor is widely applied to a variety of transmission mechanism devices including a main function of making forward and reverse turns to proceed with the positioning control and speed of action control.

In the manufacturing process of injecting the molding products, the injection molding machine will generate an axial force loading. However, a conventional servomotor drives the threaded rod of the injection molding machine to rotate so that the threaded rod will bear the axial force loading generated by the injection system device, and the injection molding machine is required to be additionally equipped with a device capable of bearing the axial force loading. Moreover, the conventional servomotor indirectly drives the threaded rod of the injection molding machine to rotate through the axial force loading device, thereby enabling the kinetic energy to be weakened, and the complicated structure of the injection system device and the higher accumulating tolerance of assemble will cause the precision degree of horizontal and height of the threaded rod to be offset and further cause the consume of components of the machine and the breakage of the threaded rod, and therefore the quality of the injecting molded products and power consumption will be affected. In view of this, the inventor of the present invention carried out in-depth research to solve the above problem and finally developed the present invention.

### SUMMARY OF THE INVENTION

It is a primary objective of the present invention to provide a stock servomotor structure capable of bearing the axial force loading generated by the injection molding machine in the manufacturing process of injecting molded products, thereby improving the smooth operation and reducing the consumption of the components of the machine.

To achieve the above-mentioned objective, the stock servomotor structure of the present invention comprises a shell, a rotor shaft, a front cover and a rear cover, wherein, an accommodating space is configured inside the shell, and a convex ring part is provided on one side of the rotor shaft and an opening is provided on one side end of the rotor shaft, wherein the opening is sleeved with the threaded rod of an injection molding machine and rightly secured with the threaded rod via a fixing ring; the front cover has a single row tapered roller bearing and a spherical roller thrust bearing, wherein individual sides of the single row tapered roller bearing and the spherical roller thrust bearings are mutually against the convex ring part of the rotor shaft and a positioning seat is used to fix the single row tapered roller bearing and the spherical roller thrust bearing inside the front cover, wherein the positioning seat is designed to cover one end of the stock servomotor, the single row tapered roller bearing is embedded inside the concave groove of the positioning seat, the spherical roller thrust bearing is embedded inside the concave groove on the rear end of the front cover, the front cover is tightly secured with the shell via the screws and a through hole is configured on the two sides of the front cover; and, the rear cover has a rolling bearing embedded inside the concave groove of the rear cover and the rear cover is tightly secured with the shell via the screws, thereby the rotor shaft passing through the shell, the front cover and rear cover to be fixed inside the accommodating space of the shell and clamping the rotor shaft via the single row tapered roller bearing, the spherical roller thrust bearings, and the rolling bearing.

According to the above-mentioned stock servomotor structure of the injection molding machine, the through hole is defined to provide a piston rod of the injection molding machine to be fixed.

As described above, the stock servomotor configured with the single row tapered roller bearing, the spherical roller thrust bearing and the rolling bearing to clamp the rotor shaft can bear the axial force loading generated by the injection molding machine in the manufacturing process of injecting molded products, and the stock servomotor is to directly drive the threaded rod of the injection molding machine to rotate, thereby improving the smooth operation, reducing the consumption of the components of the machine and saving energy consumption. The stock servomotor has the function of bearing axial force loading of the injection molding machine and therefore the injection molding machine is not necessary to be configured with additional device capable of bearing the axial force loading, thereby enabling the structure of the injection molding machine to be more concise and reducing the cost to set up the machine.

Other features and advantages of the present invention will become apparent from the following description of the invention which refers to the accompanying embodiments and drawings.

### BRIEF DESCRIPTION OF THE DRAWINGS

FIG. 1 is a perspective view of an embodiment of the present invention.

FIG. 2 is an exploded view of an embodiment of the present invention.

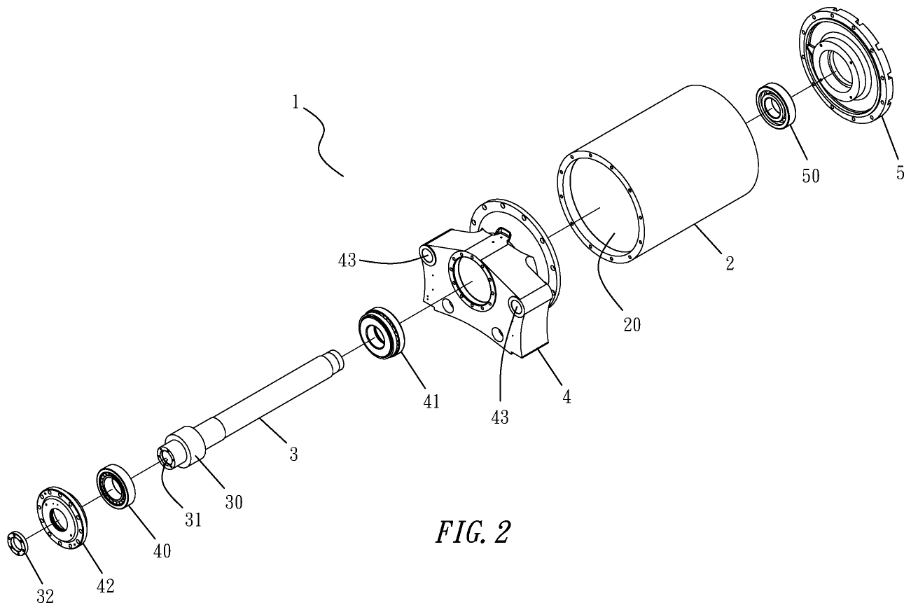

FIG. 3 is a sectional view of an embodiment of the present invention.

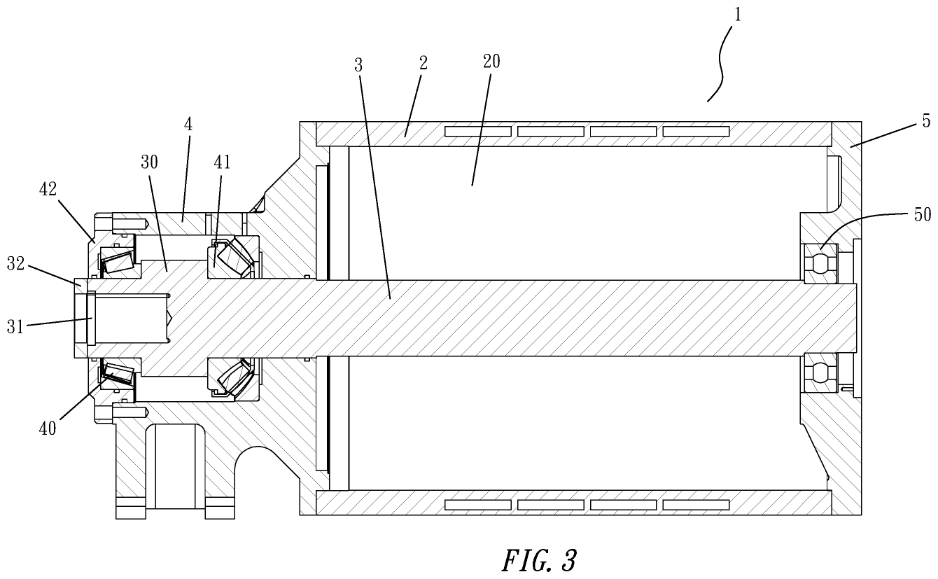

FIG. 4 is an assembly view of an embodiment of the present invention.

### DETAILED DESCRIPTION OF EMBODIMENTS OF THE INVENTION

To state in advance, the article “one” and “the” used in the descriptions of embodiments and claims can refer to single or plurality unless a specific limitation is made on the article in the specifications.

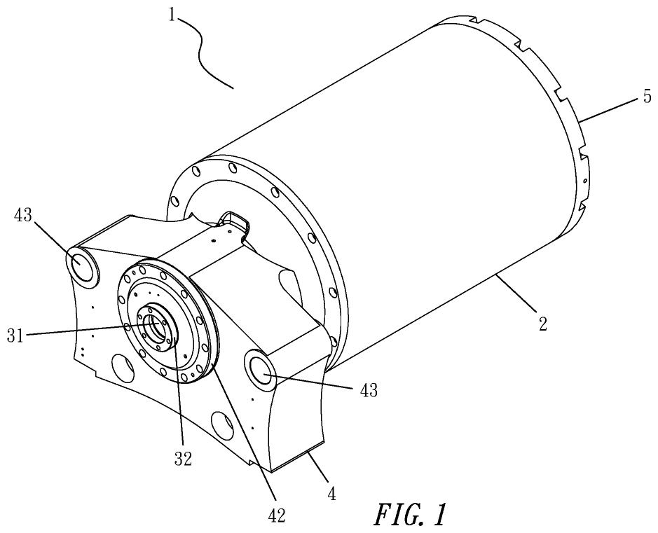

With reference to FIGS. 1˜3, the stock servomotor 1 structure of the present invention comprises a shell having an accommodating space inside; a rotor shaft 3 having a convex ring part 30 on one side and an opening 31 on one side end, wherein the opening 31 is sleeved with a threaded rod A1 of the injection molding machine and tightly secured with the threaded rod A1 through a fixing ring 32; a front cover 4 having a single row tapered roller bearing 40 and a spherical roller thrust bearing 41, wherein individual sides of the single row tapered roller bearing 40 and the spherical roller thrust bearing 41 are mutually against the convex ring part 30 of the rotor shaft 3 and a positioning seat 42 is used to fix the single row tapered roller bearing 40 and the spherical roller thrust bearing 41 inside the front cover 4, the positioning seat 42 is designed to cover one end of the stock servomotor 1, the single row tapered roller bearing 40 is embedded inside the concave groove of the positioning seat 42, the spherical roller thrust bearings 41 is embedded inside the concave groove on the rear end of the front cover 4, the front cover 4 is tightly secured with the shell 2 via a screw, a through hole 43 is configured on the two sides of the front cover 4, the through hole 43 is defined to provide the piston rod A2 of the injection molding machine to be fixed; and a rear cover 5 having a rolling bearing 50 embedded inside the concave groove of the rear cover 5, the rear cover 5 is tightly secured with the shell 2 via the screws and thereby the rotor shaft 3 passes through the shell 2, the front cover 4 and the rear cover 5 to be fixed inside the accommodating space 20 of the shell 2 and clamps the rotor shaft 3 through the single row tapered roller bearing 40, the spherical roller thrust bearing 41 and the rolling bearing 50.

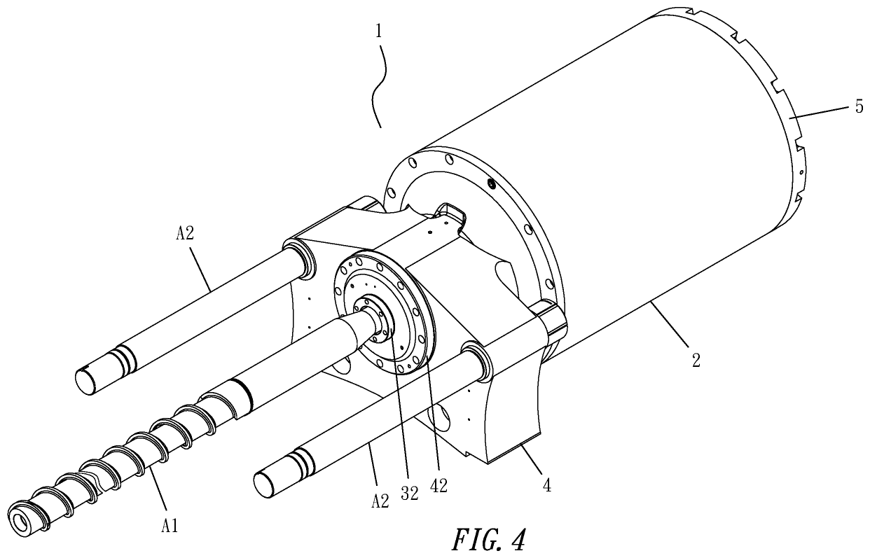

With reference to FIG. 4, the single row tapered roller bearing 40 and the spherical roller thrust bearing 41 are used to clamp the rotor shaft 3 and the single row tapered roller bearing 40 has a low friction and a high axial force loading and can bear the injecting back force generated in the manufacturing process, and the spherical roller thrust bearing 41 has a plenty of unsymmetrical rollers capable of bearing the injecting back force generated in the manufacturing process, thereby enabling the feeder servomotor 1 to bear the axial force loading generated by the injection molding machine in the manufacturing process of injecting molded product, improving smooth operation and reducing the consumption of the components of the machine and saving energy. Moreover, the stock servomotor 1 is to directly drive the threaded rod A1 of the injection molding machine to rotate and have the function to bear the axial force loading of the injection molding machine, and the injection molding machine is not necessary to be additionally configured with a device capable of bearing the axial force loading, and therefore the structure of the injection molding machine becomes more concise and the cost to set up the machine can be reduced.

Accordingly, the present invention has the following advantages and effects:

Using the single row tapered roller bearing 40 and the spherical roller thrust bearing 41 to clamp the rotor shaft 3 can bear the axial force loading generated by the injection molding machine in the manufacturing process of injecting molded product, thereby enabling the threaded rod A1 of the injection molding machine to be aligned precisely to avoid the consumption of the machine components and the breakage of the threaded rod A1, improve smooth operation, reduce the consumption of the machine components and save energy.

The stock servomotor 1 has the function of bearing the axial force loading and is not necessary to be additionally configured with a device capable of bearing the axial force loading, thereby enabling the structure of the injection molding machine to be more concise and reducing the cost to set up the machine.

The stock servomotor 1 is to directly drive the threaded rod A1 of the injection molding machine to rotate and have great output power to reduce the consumptions of the machine components and power.

Although the invention has been explained in relation to its preferred embodiment, it is to be understood that many other possible modifications and variations can be made without departing from the spirit and scope of the invention as hereinafter claimed.

What is claimed is:

1. A stock servomotor structure of an injection molding machine, comprising:
a shell having an accommodating space inside;
a rotor shaft having a convex ring part on one side and an opening on one side end, wherein the opening being sleeved with a threaded rod of the injection molding machine and tightly secured with the threaded rod via a fixing ring;
a front cover having a single row tapered roller bearing and a spherical roller thrust bearing, wherein an individual side of the single row tapered roller bearing and the spherical roller thrust bearings being mutually against the convex ring part of the rotor shaft, a positioning seat being used to fix the single row tapered roller bearing and the spherical roller thrust bearing inside the front cover, the front cover being tightly secured with the shell via a screw and the two sides of the front cover having a through hole; and,
a rear cover having a rolling bearing, wherein the rear cover being tightly secured with the shell via a screw to enable the rotor shaft to pass through the shell, the front cover and the rear cover to be fixed inside the accommodating space of the shell and clamp the rotor shaft via the single row tapered roller bearing, the spherical roller thrust bearing and the rolling bearing.

2. The stock servomotor structure of the injection molding machine of claim 1, wherein the through hole is designed to enable a piston rod of the injection molding machine to be fixed.
